(19) United States
(12) Patent Application Publication
(10) Pub. No.: US 2024/0396152 A1
(43) Pub. Date: Nov. 28, 2024

(54) BATTERY CELL HOLDER WITH IMPROVED COOLING EFFICIENCY AND BATTERY SYSTEM INCLUDING THE SAME

(71) Applicant: HYUNDAI MOBIS CO., LTD., Seoul (KR)

(72) Inventor: Young Chan YOON, Anyang-si (KR)

(73) Assignee: HYUNDAI MOBIS CO., LTD., Seoul (KR)

(21) Appl. No.: 18/203,277

(22) Filed: May 30, 2023

(30) Foreign Application Priority Data
May 22, 2023 (KR) 10-2023-0065854

(51) Int. Cl. H01M 50/291; H01M 10/613; H01M 10/653; H01M 50/213

(52) U.S. Cl. CPC H01M 50/291; H01M 10/613; H01M 10/653; H01M 50/213

(57) ABSTRACT

The present invention relates to a battery cell holder with improved cooling efficiency and a battery system including the same. More specifically, the battery cell holder for fixing a plurality of cylindrical battery cells includes a support part that includes a through hole having a first diameter, at least a portion of an inner surface of the through hole coming into contact with an outer circumferential surface of the cylindrical battery cell to fix the cylindrical battery cell; and a stepped part that extends from the support part, includes a through hole having a second diameter, and is spaced apart from the outer circumferential surface of the cylindrical battery cell to form a predetermined gap, in which the second diameter is larger than the first diameter.

### CROSS-REFERENCE TO RELATED APPLICATIONS

This application claims priority under 35 U.S.C. § 119 to Korean Patent Application No. 10-2023-0065854, filed on May 22, 2023, in the Korean Intellectual Property Office, the disclosure of which is incorporated herein by reference in its entirety.

### TECHNICAL FIELD

The following disclosure relates to a battery cell holder and a battery system including the same, and more particularly, to a battery cell holder with improved cooling efficiency and a battery system including the same.

### BACKGROUND

With the high performance of electrification mobility, a larger cooling capacity is becoming more important to secure battery performance. FIG. 1 is a perspective view illustrating a commonly used cylindrical battery module. As illustrated in FIG. 1, the conventional cylindrical battery module includes a case 20, a plurality of connectors 30, a sensor unit 40, a bus bar 50, and the like, and a holder 10 for supporting the cell 1 may be provided in a vertical direction of the cell 1.

Here, a cooling structure applicable to the conventional cylindrical battery module may be largely divided into two types as illustrated in FIG. 2A or 2B. First, FIG. 2A is a method of cooling through a lower portion of the cell 1. In more detail, a cooling block 60 is provided below the cell 1, and since a contact area between the cell 1 and the cooling block 60 is small, there is a limit to coping with an increase in a heating value of the battery.

In addition, FIG. 2B is a method of performing cooling through a side surface of the cell 1 by applying a cooling passage 70. This method has a disadvantage in that separate appliances such as a cooling passage 80 is added to both side surfaces of the cell 1, and thus, weight and cost increase.

### RELATED ART DOCUMENT

### Patent Document

Korean Patent Publication No. 10-2501080 (“Battery Pack,” Publication Date: Feb. 17, 2023)

### SUMMARY

An embodiment of the present invention is directed to providing a battery cell holder with improved cooling efficiency capable of efficiently managing a temperature of a battery under harsh driving conditions, and a battery system including the same.

In one general aspect, a battery cell holder with improved cooling efficiency includes: a support part that includes a through hole having a first diameter, at least a portion of an inner surface of the through hole coming into contact with an outer circumferential surface of the cylindrical battery cell to fix the cylindrical battery cell; and a stepped part that extends from the support part, includes a through hole having a second diameter, and is spaced apart from the outer circumferential surface of the cylindrical battery cell to form a predetermined gap, in which the second diameter is larger than the first diameter.

The support part may include at least one slot that is formed by recessing in the support part in one direction, and has one end connected to the stepped part, and the other end connected to an outside of the battery cell holder.

A radius of the through hole having the second diameter may be larger than that of the cylindrical battery cell by 0.5 mm or more and less than 2 mm.

A height of the stepped part may be 50% or less of that of the cylindrical battery cell.

The stepped part may be spaced apart at a regular interval from the outer circumferential surface of the cylindrical battery cell.

The diameter of the through hole of the stepped part may increase as a distance from the support part increases so that a distance between the outer circumferential surface of the cylindrical battery cell and the through hole of the stepped part increases as the stepped part is far away from the support part.

In another general aspect, a battery system with improved cooling efficiency includes: a battery cell holder with improved cooling efficiency for a plurality of cylindrical battery cell including a support part that includes a through hole having a first diameter, at least a portion of an inner surface of the through hole coming into contact with an outer circumferential surface of the cylindrical battery cell to fix the cylindrical battery cell and a stepped part that extends from the support part, includes a through hole having a second diameter, and is spaced apart from the outer circumferential surface of the cylindrical battery cell to form a predetermined gap, in which the second diameter is larger than the first diameter; and a gapfiller that is provided on one side of the battery cell holder and is made of a thermally conductive material filling the gap, in which the stepped part of the battery cell holder is provided in a direction in which the gapfiller is provided.

### BRIEF DESCRIPTION OF THE DRAWINGS

FIG. 1 is a perspective view illustrating a conventional cylindrical battery module.

FIG. 2A is a perspective view illustrating a conventional bottom cooling method.

FIG. 2b is a perspective view illustrating a conventional side cooling method.

FIG. 3A is a perspective view embodying FIG. 2A.

FIG. 3B is a schematic diagram illustrating a heat transfer path according to FIG. 3A.

FIG. 4 is a perspective view illustrating a battery cell holder according to the present invention.

FIGS. 5A and 5B are schematic diagrams illustrating a comparison between a conventional battery cell holder and a battery cell holder according to the present invention.

FIGS. 6A and 6B are schematic diagrams illustrating a battery cell holder according to another embodiment of the present invention.

FIG. 7 is a graph illustrating a temperature change according to a width of a gap.

FIG. 8 is a graph illustrating a temperature change according to a height of the gap.

FIGS. 9A and 9B are diagrams illustrating a temperature comparison according to a battery cell holder structure.

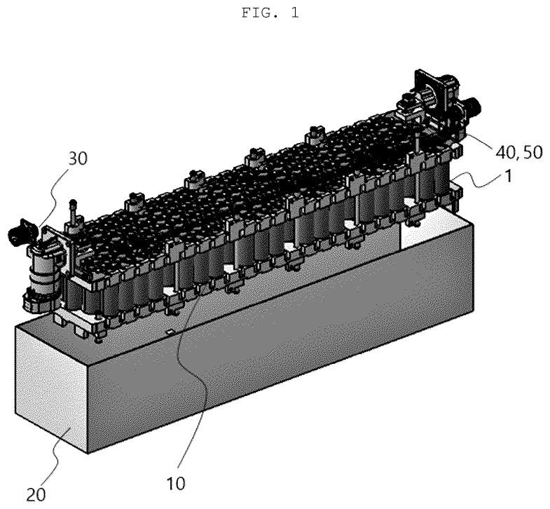

### DETAILED DESCRIPTION OF MAIN ELEMENTS

1: Cylindrical battery cell
10: Battery cell holder (conventional)
20: Case
30: Connector
40: Sensor unit
50: Bus bar
60: Cooling block
70: Gapfiller
80: Cooling passage
1000: Battery cell holder
110: Support part
111: Slot
120: Stepped part
121: Gap

### DETAILED DESCRIPTION OF EMBODIMENTS

In order to explain the present invention and the operational advantages of the present invention and the objects achieved by the practice of the present invention, preferred embodiments of the present invention will be exemplified below and the present invention will be described with reference thereto.

First, the terms used in this application are only used to describe specific embodiments, and are not intended to limit the present invention, and singular expressions may include plural expressions unless the context clearly indicates otherwise. It should be understood that terms “comprise” and “have” used in the present specification, specify the presence of features, numerals, steps, operations, components, parts mentioned in the present specification, or combinations thereof, but do not preclude the presence or addition of one or more other features, numerals, steps, operations, components, parts, or combinations thereof.

In describing embodiments of the present invention, well-known functions or constructions will not be described in detail since they may unnecessarily obscure the understanding of the present invention.

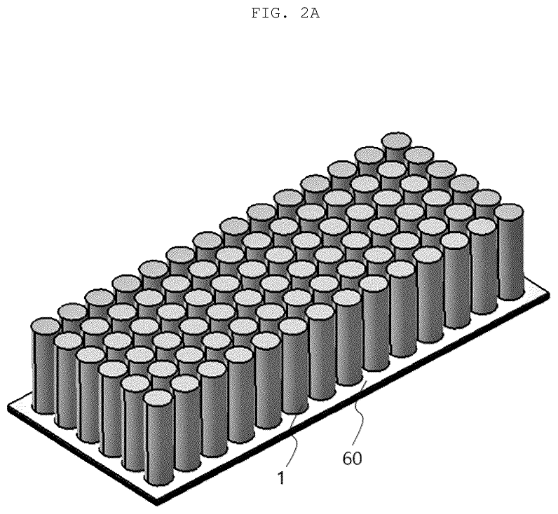

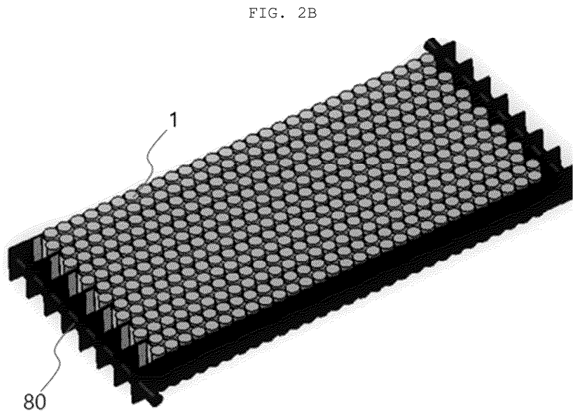

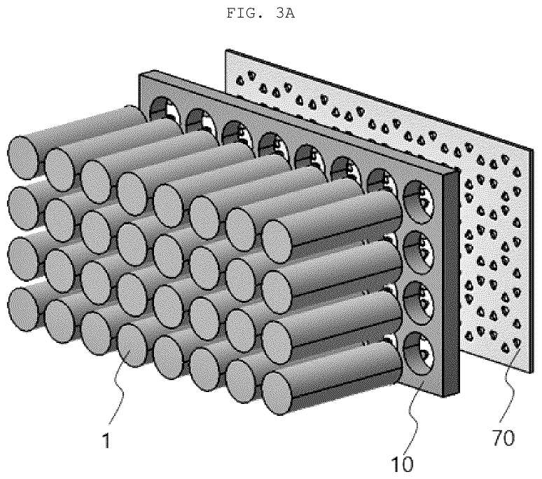

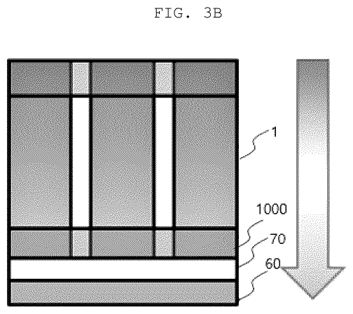

FIG. 3A is a perspective view embodying FIG. 2A, and FIG. 3B is a schematic diagram illustrating a heat transfer path according to FIG. 3A.

According to the conventional lower cooling method, cooling of a lower portion of a cylindrical cell may be performed as illustrated in FIG. 3A or 3B.

In particular, as illustrated in FIG. 3A, the conventional lower cooling method is a structure in which a cell holder 10 supports upper and lower portions of the cylindrical battery cell 1, and in particular, the structure in both ends of the cylindrical battery cell 1 is directly supported.

In addition, the cylindrical battery cell 1 may be attached to a heat transfer interface material of a gapfiller (thermal interface material (TIM) 70) like a cell holder 1000.

In this case, the gapfiller 70 is a liquid having flowability and means a material that is hardened after a predetermined time.

In this structure, the cooling efficiency is not high because the cylindrical battery cell 1 contacts a cooling surface only through a bottom surface, which is a very local portion, and heat transfer is performed.

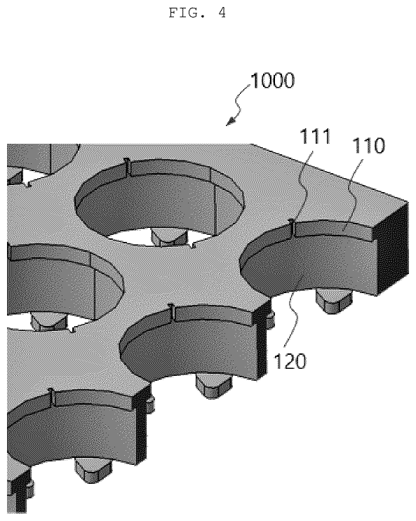

FIG. 4 is a perspective view illustrating the battery cell holder according to the present invention.

As illustrated in FIG. 4, the battery cell holder 1000 fixing the plurality of cylindrical battery cells 1 according to the present invention may include a support part 110 and a stepped part 120.

The support part 110 may include a through hole having a first diameter.

In this case, at least a portion of an inner surface of a through hole having a first diameter may come into contact with an outer circumferential surface of the cylindrical battery cell 1, and thus, may fix the cylindrical battery cell 1.

The stepped part 120 may include a through hole extending from the support part 110 and having a second diameter.

In this case, the stepped part 120 may be spaced apart from the outer circumferential surface of the cylindrical battery cell 1 to form a predetermined gap.

Specifically, the stepped part 20 may be spaced apart at a regular interval from the outer circumferential surface of the cylindrical battery cell 1.

Accordingly, a vertical cross section of the gap 121 formed between the cylindrical battery cell 1 and the stepped part 120 may have a rectangular shape.

Accordingly, the gapfiller 70 may be introduced into a width from the stepped part 120 side of a lower end of the battery cell holder 1000 to fill the gap 121.

In addition, when the cylindrical battery cell 1 and the battery cell holder 1000 are attached to the gapfiller 70, the gapfiller 70 may naturally flow into the gap 121 of the cell holder 1000 by a pressing force, and thus, may surround and be in contact with a side surface of the cylindrical battery cell 1 inside the battery cell holder 1000.

Meanwhile, as described above, air bubbles may be formed while the gap 121 is filled with the gapfiller 70.

To prevent this, in the battery cell holder 1000 according to another embodiment of the present invention, as shown in FIG. 4, at least one slot 111 may be formed in the support part 110.

Specifically, the slot 111 may be recessed in one direction of the support part 110.

More specifically, one end is connected to the stepped part 120 and the other end is connected to the outside of the battery cell holder 1000, so air is discharged through the slot 111 while the gapfiller 70 fills the gap 121, thereby preventing the air bubbles from being formed.

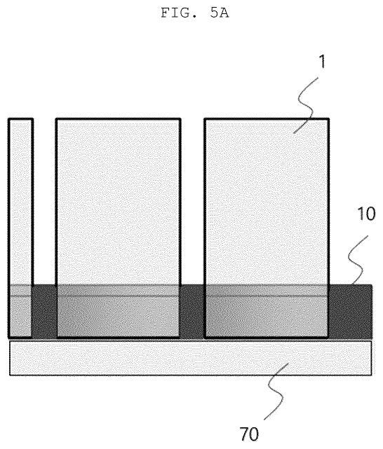

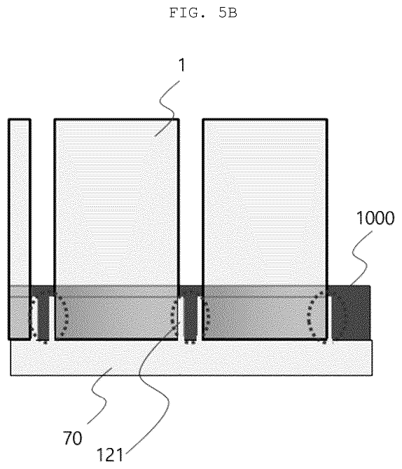

FIGS. 5A and 5B are diagrams schematically illustrating a comparison between the conventional battery cell holder and the battery cell holder according to the present invention.

As illustrated in FIGS. 5A and 5B, the conventional battery cell holder 10 includes a plurality of cylindrical holes 100 into which the plurality of cylindrical battery cells 1 are inserted.

Accordingly, it can be seen that the gapfiller 70 is in contact with the bottom surfaces of the plurality of cylindrical battery cells 1, and heat may be transferred only through the bottom surfaces.

On the other hand, in the case of the battery cell holder 1000 according to the present invention, the gapfiller 70 is introduced through the gap 121 formed by the stepped part 120 to increase the contact surface, thereby increasing a heat transfer area.

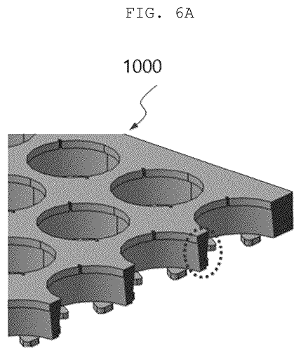

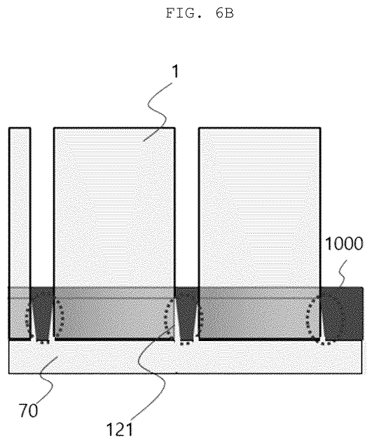

FIG. 6A is a perspective view of a battery cell holder according to another embodiment of the present invention, and FIG. 6B is a schematic view illustrating a battery cell holder according to another embodiment of the present invention.

As illustrated in FIG. 6A or 6B, the gap 121 according to the present invention may include a cone-type inclined surface.

Specifically, the stepped part 120 may have a shape in which a distance from an outer circumferential surface of the cylindrical battery cell 1 increases toward one side of the cylindrical battery cell 1.

Specifically, the diameter of the through hole of the stepped part 120 may increase as a distance from the support part 110 increases so that a distance between the outer circumferential surface of the cylindrical battery cell 1 and the through hole of the stepped part 120 increases as the stepped part is far away from the support part 110.

Accordingly, a vertical cross section of the gap 121 formed between the cylindrical battery cell 1 and the stepped part 120 may have a right-angled triangular shape.

This is to reduce the amount of the gapfiller 70 while securing a contact area of the plurality of cylindrical battery cells 1. Therefore, since the specific gravity of the gapfiller 70 is high compared to the material of the battery cell holder 1000, it is possible to reduce weight.

In this case, the material of the battery cell holder 1000 may be polypropylene, polyethylene, or the like.

In addition, in changing the shape of the gap 121, it is preferable to apply when the cooling performance is shown to be at the same level and the maximum temperature margin is secured.

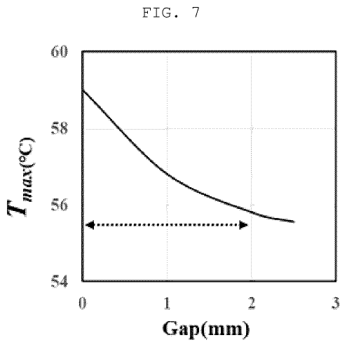

FIG. 7 is a graph illustrating a temperature change according to a width of a gap.

It is preferable that a separation distance between the stepped part 120 and the cylindrical battery cell 1 according to the present invention is 0.5 mm or more and less than 2 mm.

Since the width of the gap formed as the stepped part 120 and the cylindrical battery cell 1 are spaced apart from each other is the same as the above-mentioned separation distance, in FIG. 7 and the following description, it will be described as the width of the gap 121.

The width of the gap 121 formed by the support part 110 and the stepped part 120 included in the battery cell holder 1000 is preferably 0.5 mm or more and less than 2 mm.

In other words, the radius of the through hole having the second diameter is preferably 0.5 mm or more and less than 2 mm compared to the radius of the cylindrical cell 1.

This is because, as illustrated in FIG. 7, the cooling efficiency tends to improve as the width of the gap 121 increases, but the improvement in cooling efficiency gradually slows down.

In addition, when the thickness of the gap 121 is 2 mm or more, the distance between the plurality of cylindrical battery cells 1 excessively increases, resulting in an increase in size.

Therefore, it is preferable that the width of the gap 121 is 0.5 mm or more and less than 2 mm.

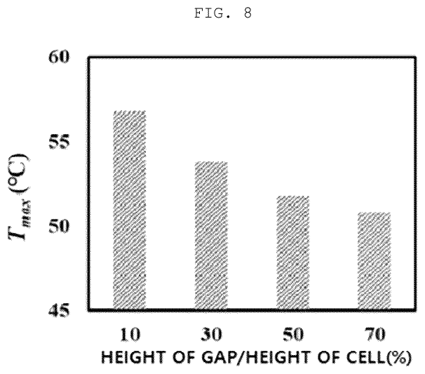

FIG. 8 is a graph illustrating a temperature change according to the height of the gap.

It is preferable that the height of the stepped part 120 according to the present invention is 50% or less of the height of the cylindrical battery cell 1.

Since the height of the stepped part 120 is the same as the height of the gap 121 described in detail in FIG. 8 and below, it is revealed that the height of the gap 121 is described below.

The height of the gap 121 formed by the support part 110 and the stepped part 120 included in the battery cell holder 1000 is preferably 50% or less of the height of the plurality of cylindrical battery cells 1.

Specifically, as illustrated in FIG. 8, it can be seen that the cooling efficiency tends to improve as the height of the gap 121 increases, but the improvement in cooling efficiency gradually slows down.

This is because the heat transfer efficiency decreases as the distance from the cooling surface increases because the thermal conductivity of the gap filler 70 is not high.

Therefore, since the cooling efficiency is not greatly improved compared to the increase in weight due to the increase in the amount of gapfiller 70 used and the increase in the material of the battery cell holder 1000, the height of the gap 121 is preferably 50% or less of that of the plurality of cylindrical battery cells 1.

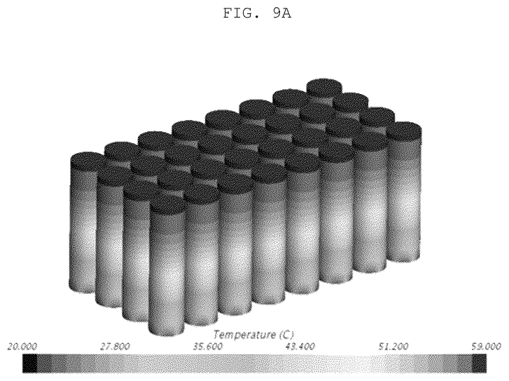

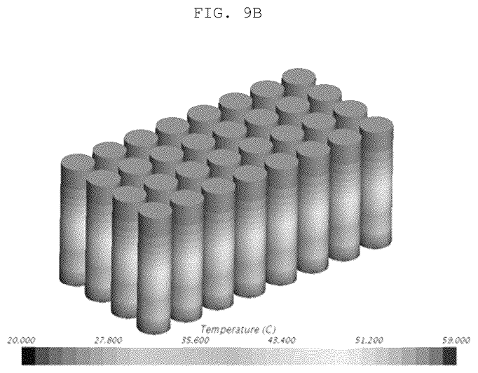

FIGS. 9A and 9B are diagrams illustrating a temperature comparison according to a battery cell holder structure.

FIG. 9A illustrates the temperature change of the cylindrical battery cell 1 in the case of the conventional battery cell holder 1000 structure, and FIG. 9B illustrates the temperature change of the cylindrical battery cell 1 appearing in the case of the battery cell holder 1000 structure according to the present invention.

In FIGS. 9A and 9B as an example, the gapfiller 70 was set to be introduced into the gap 121 of the battery cell holder 1000 by a height of 8 mm.

In addition, the width of the gap 121 was set to 1 mm.

When the heating condition in which the temperature of the cylindrical battery cell 1 rises to 59° C. in the conventional battery cell holder 1000 illustrated in FIGS. 9A and 9B is equally applied to the structure of the battery cell holder 1000 of the present invention, as illustrated in FIG. 9B, it can be confirmed that the temperature of the cylindrical battery cell 1 is 57° C., lowered by about 2° C. compared to the related art.

Therefore, according to the battery cell holder 1000 according to various embodiments of the present invention, there is an effect that the cooling efficiency of the cylindrical battery cell 1 may increase compared to the related art without adding a separate appliance including a cooling passage or the like as in the related art.

Meanwhile, a battery system according to another embodiment of the present invention may include the battery cell holder 1000 and the gap filler 70.

Since the battery cell holder 1000 includes the above-described features, a description thereof will be omitted.

The gapfiller 70 includes a thermally conductive material, is a liquid having fluidity, and means a material that is hardened after a predetermined time.

In addition, the gapfiller 70 is provided on one side of the cylindrical battery cell 1 to fill a gap generated by the battery cell holder 1000.

In this case, the stepped part 120 of the battery cell holder 1000 may be provided in a direction in which the gapfiller 70 is provided.

Through this structure, as the gap filler 70 fills the gap, the contact area with the cylindrical battery cell 1 increases, so the cooling efficiency of the cylindrical battery cell 1 may increase compared to the related art.

As described above, according to the battery cell holder with improved cooling efficiency and a battery system including the same according to various embodiments of the present invention, it is possible to improve cooling performance of the battery through an application of a cylindrical cell insert type holder.

In addition, there is an effect that weight and cost do not increase because it can be applied through modification of the conventional cooling method without adding a separate appliance.

Although preferred embodiments the present invention have been described above, the embodiments disclosed in the present invention are only for explaining, not limiting, the technical spirit of the present invention. Accordingly, the technical spirit of the present invention includes not only each disclosed embodiment, but also a combination of the disclosed embodiments, and further, the scope of the technical spirit of the present invention is not limited by these embodiments. In addition, many modifications and alterations of the present invention may be made by those skilled in the art to which the present invention pertains without departing from the spirit and scope of the accompanying claims. In addition, it is to be considered that all of these modifications and alterations fall within the scope of the present invention.

What is claimed is:

1. A battery cell holder with improved cooling efficiency for fixing a plurality of cylindrical battery cells, the battery cell holder comprising:
a support part that includes a through hole having a first diameter, at least a portion of an inner surface of the through hole coming into contact t with an outer circumferential surface of the cylindrical battery cell to fix the cylindrical battery cell; and
a stepped part that extends from the support part, includes a through hole having a second diameter, and is spaced apart from the outer circumferential surface of the cylindrical battery cell to form a predetermined gap,
wherein the second diameter is larger than the first diameter.

2. The battery cell holder of claim 1, wherein the support part includes at least one slot that is formed by recessing in the support part in one direction, and has one end connected to the stepped part, and the other end connected to an outside of the battery cell holder.

3. The battery cell holder of claim 2, wherein a radius of the through hole having the second diameter is larger than that of the cylindrical battery cell by 0.5 mm or more and less than 2 mm.

4. The battery cell holder of claim 2, wherein a height of the stepped part is 50% or less of that of the cylindrical battery cell.

5. The battery cell holder of claim 1, wherein the stepped part is spaced apart at a regular interval from the outer circumferential surface of the cylindrical battery cell.

6. The battery cell holder of claim 1, wherein the diameter of the through hole of the stepped part increases as a distance from the support part increases so that a distance between the outer circumferential surface of the cylindrical battery cell and the through hole of the stepped part increases as the stepped part is far away from the support part.

7. A battery system, comprising:
a battery cell holder including:
a support part that includes a through hole having a first diameter, at least a portion of an inner surface of the through hole coming into contact with an outer circumferential surface of the cylindrical battery cell to fix the cylindrical battery cell; and
a stepped part that extends from the support part, includes a through hole having a second diameter, and is spaced apart from the outer circumferential surface of the cylindrical battery cell to form a predetermined gap,
wherein the second diameter is larger than the first diameter; and
a gapfiller that is provided on one side of the battery cell holder and is made of a thermally conductive material filling the gap,
wherein the stepped part of the battery cell holder is provided in a direction in which the gapfiller is provided.
